(19) United States
(12) Patent Application Publication
(10) Pub. No.: US 2007/0297432 A1
(43) Pub. Date: Dec. 27, 2007

(54) Host-Controlled Network Interface Filtering Based on Active Services, Active Connections and Active Protocols

(76) Inventor: David Alan Christenson, Fergus Falls, MN (US)

Correspondence Address: MARTIN & ASSOCIATES, LLC, P.O. BOX 548, CARTHAGE, MO, 64836-0548, US

(21) Appl. No.: 11/425,493

(22) Filed: Jun. 21, 2006

(51) Int. Cl. H04L 12/56

(52) U.S. Cl. 370/412; 370/463

(57) ABSTRACT

A network interface performs filtering of inbound packets based on information maintained in a shared memory that indicates active services, active connections and active protocols. A network control mechanism running on the host computer system writes information to the shared memory to indicate which services, connections and protocols are currently active. When the network interface receives an inbound packet, a filter mechanism reads the header information, and reads information in the shared memory to determine whether the packet targets an active service, connection or protocol. If the packet does not target an active service, an active connection, or an active protocol, the filter mechanism discards the packet. In this manner effective filtering of network packets is achieved in the network interface under control of the host that writes the information to the shared memory.

### BACKGROUND

1. Technical Field

This disclosure generally relates to computer systems, and more specifically relates to network communications between computer systems.

2. Background Art

Computer networks allow different computer systems to communicate with each other via the network that interconnects the computer systems. Network communications are typically performed using packets of information. A packet typically includes a header portion that contains information about the packet, and a data portion that contains the information that needs to be transmitted.

In modern networked computer systems, one or more of the computers on the network may be coupled to other computer networks, such as the internet. This allows a server on the computer network to receive many unwanted packets. A server computer system may receive as many unwanted packets as it does good packets that are actually delivered to applications. In a TCP/IP system, these unwanted packets are commonly delivered by the IP protocol to the TCP or UDP transport, then discarded. Unwanted packets include non-malicious broadcast packets, malicious port scans, restricted protocol attacks, restricted service attacks and other threats introduced by the global internet connectivity. These unwanted packets bog down or incapacitate servers, consuming valuable processor cycles because the main processor is typically interrupted to process each unwanted packet. The net result is considerable processor overhead in processing unwanted packets, which degrades performance of the computer system.

Some mechanisms that filter unwanted packets are known in the art. For example, in U.S. Pat. No. 6,876,653 to Ambe et al., packets are read and may be filtered based on the type of packet received. The Ambe method is used in network devices such as routers to filter unwanted packets in a router before they arrive at a server. The Ambe method if applied to a server would not solve the problem of the server having to process unwanted packets.

One way to avoid server overhead in processing unwanted packets is to perform packet filtering at the network interface. One example of such filtering is shown in U.S. Patent Application Publication No. US 2002/0083351 A1 to Brabenac, published Jun. 27, 2002. The Brabenac method is designed to avoid waking a host to process unwanted packets based on a port identifier. The filtering in Brabenac would not effectively filter many of the unwanted packets, and would not solve the problem of avoiding wakeup messages for a busy server that is seldom or never idle. Without a way to perform packet filtering in a network interface that effectively blocks most unwanted packets, server computer system will continue to be burdened with the overhead of processing unwanted packets.

### BRIEF SUMMARY

A network interface performs filtering of inbound packets based on information maintained in a shared memory that indicates active services, active connections and active protocols. A network control mechanism running on the host computer system writes information to the shared memory to indicate which services, connections and protocols are currently active. When the network interface receives an inbound packet, a filter mechanism reads the header information, and reads information in the shared memory to determine whether the packet targets an active service, connection or protocol. If the packet does not target an active service, an active connection, or an active protocol, the filter mechanism discards the packet. In this manner effective filtering of network packets is achieved in the network interface under control of the host that writes the information to the shared memory. This allows the host to very quickly block packets from a hacker by designating the service, connection or protocol used by the hacker as inactive.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of an apparatus that includes host-based packet filtering in the network interface based on active services, active connections and active protocols;

FIG. 2 is a simplified block diagram showing host-based packet filtering in a network interface;

FIG. 3 is a flow diagram of a prior art method for a server computer system to process inbound packets;

FIG. 4 is a flow diagram of a prior art method for programming a port filter;

FIG. 5 is a flow diagram of a prior art method for processing an inbound packet;

FIG. 6 is a flow diagram of a method for a network interface to process an inbound packet;

FIG. 7 is a block diagram of a sample network packet;

FIG. 8 is a flow diagram showing one possible implementation for step 620 in FIG. 6;

FIG. 9 is a flow diagram showing one possible implementation for step 630 in FIG. 6;

FIG. 10 is a flow diagram showing one possible implementation for step 640 in FIG. 6;

FIG. 11 is an interaction diagram showing filtering in a network interface based on active services;

FIG. 12 is an interaction diagram showing filtering in a network interface based on active protocols;

FIG. 13 shows an active connection hash table for mapping bits to corresponding connections;

FIG. 14 shows a hash algorithm that may be used in the active connection hash table in FIG. 13; and

FIG. 15 is an interaction diagram showing filtering in a network interface based on active connections.

### DETAILED DESCRIPTION

An inbound packet filter mechanism in a network interface allows filtering network packets at the network interface, thereby relieving the computer system of the processor overhead of processing unwanted packets. A network control mechanism, such as a TCP/IP stack, writes to a shared memory to indicate active services, active connections and active protocols. The inbound packet filter mechanism in the network interface receives a packet, reads the packet for a corresponding service, connection or protocol, then checks the shared memory to see if the service, connection or protocol for the packet is an active service, an active connection, or an active protocol. In this manner the network interface may block unwanted packets without the host processor processing the unwanted packets. In addition, hacker attacks may be quickly thwarted by making the service, connection or protocol in the hacker's packet inactive, resulting in instant blocking of the hacker's packets by the network interface.

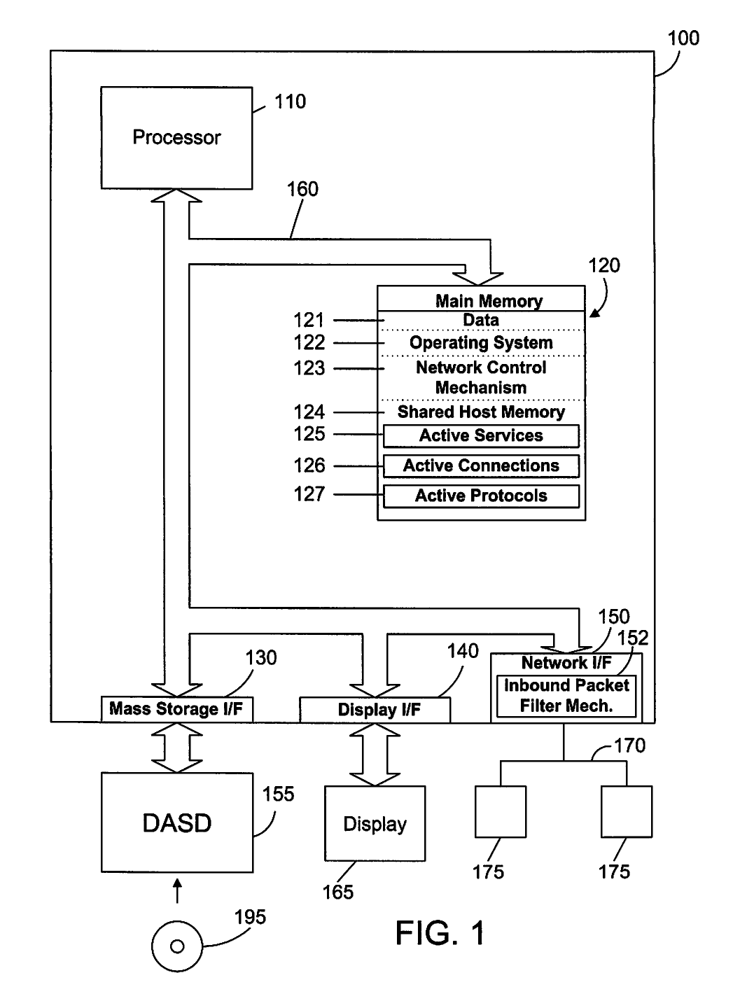

Referring to FIG. 1, a computer system 100 is one suitable implementation of an apparatus that performs packet filtering in a network interface based on active services, active connections, and active protocols. Computer system 100 is an IBM eServer System i computer system. However, those skilled in the art will appreciate that the disclosure herein applies equally to any computer system, regardless of whether the computer system is a complicated multi-user computing apparatus, a single user workstation, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as a direct access storage device 155, to computer system 100. One specific type of direct access storage device 155 is a readable and writable CD-RW drive, which may store data to and read data from a CD-RW 195.

Main memory 120 preferably contains data 121, an operating system 122, a network control mechanism 123, and shared host memory 124. Data 121 represents any data that serves as input to or output from any program in computer system 100. Operating system 122 is a multitasking operating system known in the industry as i5/OS; however, those skilled in the art will appreciate that the spirit and scope of this disclosure is not limited to any one operating system. Network control mechanism 123 controls network communications in computer system 100. One suitable network control mechanism 123 is a TCP/IP stack.

Shared host memory 124 provides a common storage area that may be accessed by the network control mechanism 123 and by the inbound packet filter mechanism 152 in the network interface 150. The network control mechanism 123 writes to the shared host memory 124 to indicate active services 125, active connections 126 and active protocols 127. This information in the shared memory is preferably in the form of bitmaps that have a bit that corresponds to the various services, connections and protocols supported by computer system 100.

Computer system 100 utilizes well known virtual addressing mechanisms that allow the programs of computer system 100 to behave as if they only have access to a large, single storage entity instead of access to multiple, smaller storage entities such as main memory 120 and DASD device 155. Therefore, while data 121, operating system 122, network control mechanism 123 and shared host memory 124 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122.

Although computer system 100 is shown to contain only a single processor and a single system bus, those skilled in the art will appreciate that packet filtering in a network interface may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that the packet filtering in a network interface may be performed in computer systems that simply use I/O adapters to perform similar functions.

Display interface 140 is used to directly connect one or more displays 165 to computer system 100. These displays 165, which may be non-intelligent (i.e., dumb) terminals or fully programmable workstations, are used to allow system administrators and users to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect other computer systems and/or workstations (e.g., 175 in FIG. 1) to computer system 100 across a network 170. Network interface 150 and network 170 broadly represent any suitable way to interconnect computer systems, regardless of whether the network 170 comprises present-day analog and/or digital techniques or via some networking mechanism of the future. In addition, many different network protocols can be used to implement a network. These protocols are specialized computer programs that allow computers to communicate across network 170. TCP/IP (Transmission Control Protocol/Internet Protocol) is an example of a suitable network protocol. Network interface 150 includes an inbound packet filter mechanism 152 that provides effective filtering of unwanted packets without the network control mechanism 123 or processor 110 having to process the unwanted packets. When an inbound network packet is received by the network interface 150, the inbound packet filter mechanism 152 reads the packet to determine a corresponding service, connection or protocol for the packet. The inbound packet filter mechanism 152 then reads the shared host memory 124, preferably via Direct Memory Access (DMA), to determine the active services 125, the active connections 126, and/or the active protocols 127. If the corresponding service, connection or protocol for the packet is not an active service, an active connection, or an active protocol, the inbound packet filter mechanism 152 discards the packet without notifying the network control mechanism 123 or the processor 110 of the unwanted packet. In this manner effective filtering of unwanted packets is done at the network interface 150 without creating significant overhead for processor 110. A network interface card (NIC) is one suitable example of a network interface 150.

At this point, it is important to note that while the description above is in the context of a fully functional computer system, those skilled in the art will appreciate that the inbound packet filter mechanism may be distributed as a program product in a variety of forms, and that the claims extend to all suitable types of computer-readable media used to actually carry out the distribution. Examples of suitable computer-readable media include: recordable media such as floppy disks and CD-RW (e.g., 195 of FIG. 1), and transmission media such as digital and analog communications links.

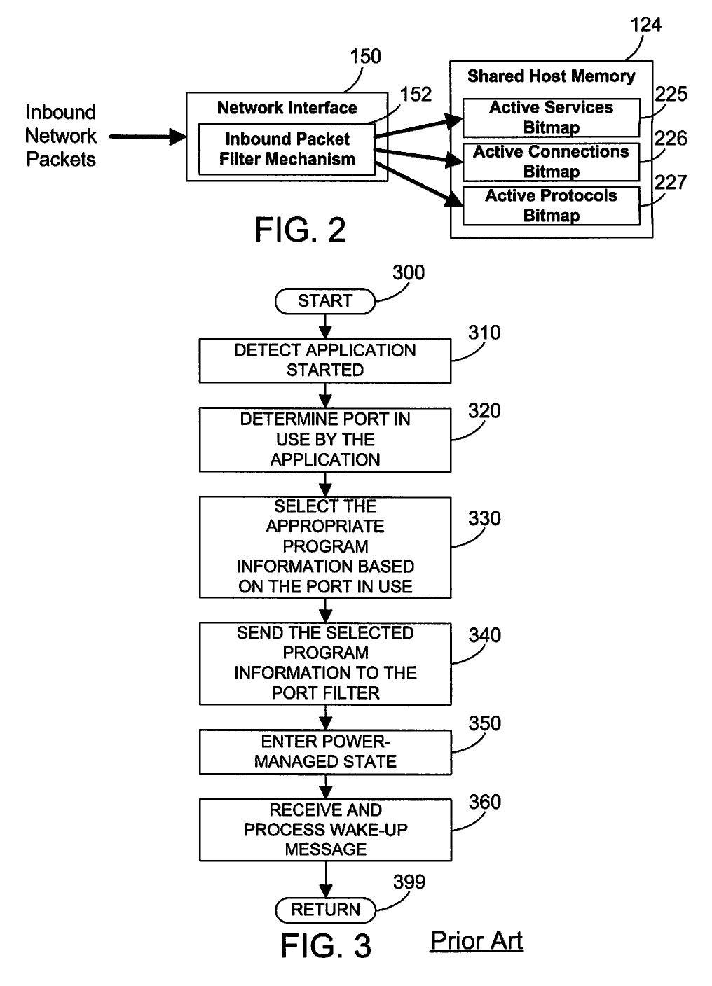

FIG. 2 is a simplified representation showing how unwanted inbound packets may be filtered by the network interface 150. The shared host memory 124 in FIG. 2 includes an active services bitmap 225, an active connections bitmap 226, and an active protocols bitmap 227. The active services bitmap 225 is one suitable implementation that indicates active services 125 shown in FIG. 1. The active services bitmap 225 preferably has a size sufficient to accommodate all active services on computer system 100. In one particular implementation, active services bitmap 225 is 8192 bytes containing 1 bit for each possible service, or 65536 bits. If a bit is 1, that implies that the corresponding service is active. If a bit is 0, that implies that the corresponding service is inactive.

The active connections bitmap 226 may be as small as 8192 bytes or much larger (e.g., 1 megabyte). The active connections bitmap 226 is one suitable implementation that indicates active connections 126 shown in FIG. 1. A large active connections bitmap 226 allows the network interface 150 to more accurately discard unwanted packets. The source address and source port are hashed to produce an index into the active connections bitmap 226 to select the bit corresponding to an active connection. Since there may not be enough bits to represent all possible active connections, collisions are possible and one bit may be shared by more than one active connection. Therefore, there is a slight possibility that the inbound packet filter mechanism 152 will allow an unwanted packet through.

The active protocols bitmap 227 preferably has a size sufficient to accommodate all active protocols on computer system 100. The active protocols bitmap 227 is one suitable implementation that indicates active protocols 127 shown in FIG. 1. In one particular implementation, active protocols bitmap 227 is a 32 byte bitmap containing 1 bit for each possible protocol, or 256 bits. If a bit is 1, that implies that the corresponding protocol is active. If a bit is 0, that implies that the corresponding protocol is inactive.

The bitmaps 225, 226 and 227 shown in FIG. 2, when used in a TCP/IP system, may be thought of as a compressed representation of the TCP/IP stack. The bitmaps are preferably updated by the TCP and IP protocol layers of the TCP/IP stack. In the system shown in FIG. 2, when an inbound packet is received by the network interface 150, the inbound packet filter mechanism 152 reads the packet header to determine a corresponding service, connection or protocol specified in the inbound packet. The inbound packet filter mechanism 152 then reads one or more of the active services bitmap 225, the active connections bitmap 226, and the active protocols bitmap 227 to determine whether the service, connection or protocol specified in the header of the inbound packet is active. If so, the network interface 150 sends the packet to an appropriate target within computer system 100, such as to network control mechanism 123. If the service, connection or protocol specified in the network packet is inactive, the packet is deleted by the inbound packet filter mechanism 152, thereby providing effective packet filtering within the network interface 150 that autonomically evolves and changes based on the services, connections and protocols that are currently active, and without any required input from a user.

Note that the inbound packet filter mechanism 152 relies upon some other mechanism, such as the operating system 122 or the network control mechanism 123, to write to the shared host memory 124 to indicate which services, connections and protocols are active. The overhead to maintain the active services 125, active connections 126, and active protocols 127 is very low. When these are bitmaps as shown at 225, 226 and 227 in FIG. 2, maintaining the bitmaps can be done by simply setting or clearing bits. As a result, the very small overhead of maintaining the information in the shared host memory 124 is far outweighed by the improvement in performance that results from preventing unwanted packets to reach the network control mechanism 123 or the processor 110. Furthermore, hacker attacks may be quickly and efficiently thwarted using the bitmaps 225, 226 and 227 shown in FIG. 2. The host server can instantly block a service, a connection, or a protocol with a flip of a bit to defend against an attack or to temporarily shutdown a service for maintenance.

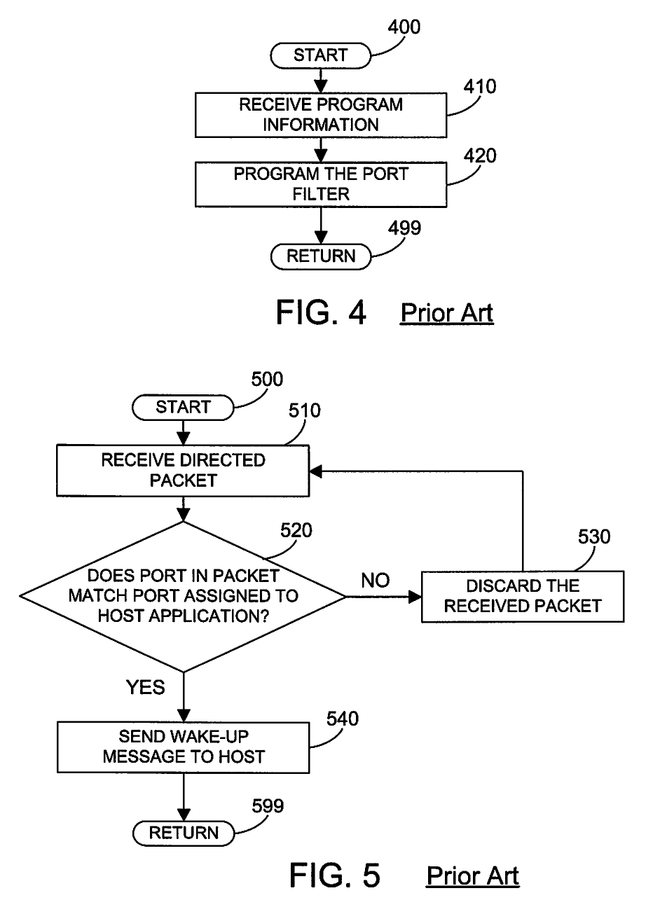

U.S. Patent Application Publication No. US 2002/0083351 A1 to Brabenac discloses a way to reduce wake-up messages in an idle computer system by identifying and discarding some unwanted packets in the network adapter. FIGS. 3-5 herein are representations of FIGS. 3-5 in Brabenac. These figures are not discussed in detail because they are discussed in detail in Brabenac. The packet filtering in Brabenac is based on ports (services), and no filtering based on connections or protocols is provided.

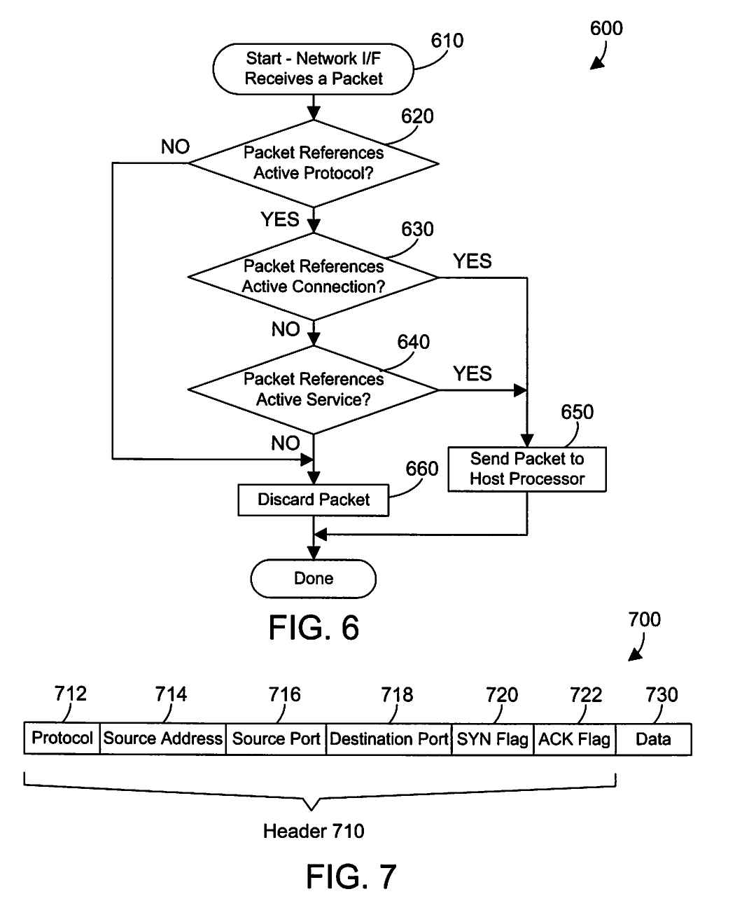

Referring to FIG. 6, a method 600 begins when the network interface receives an inbound packet (step 610). If the packet does not reference an active protocol (step 620=NO), the packet is discarded (step 660). If the packet references an active protocol (step 620=YES), method 600 checks to see if the packet references an active connection (step 630). If so (step 630=YES), the packet is sent to the host processor (step 650). If the packet does not reference an active connection (step 630=NO), method 600 checks to see if the packet references an active service (step 640). If so (step 640=YES), the packet is sent to the host processor (step 650). If the packet does not reference an active service (step 640=NO), the packet is discarded (step 660). Discarding the packet in the network interface results in improved performance by not burdening the processor 110 of the task of processing unwanted packets. Note that step 650 of sending the packet to the host processor may include sending the packet to a network control mechanism 123 such as a TCP/IP stack, which is executed by processor 110.

Referring to FIG. 7, a sample packet 700 includes a header portion 710 and a data portion 730. In a TCP/IP system, the header portion 710 may include a specified protocol 712, a source address 714, a source port 716, destination port 718, a SYN flag 720, and an ACK flag 722. Note that an IP header or a TCP header includes may other fields not shown in FIG. 7. The header portion 710 of packet 700 is read by the inbound packet filter mechanism to determine whether the packet references an active protocol, an active connection, or an active service.

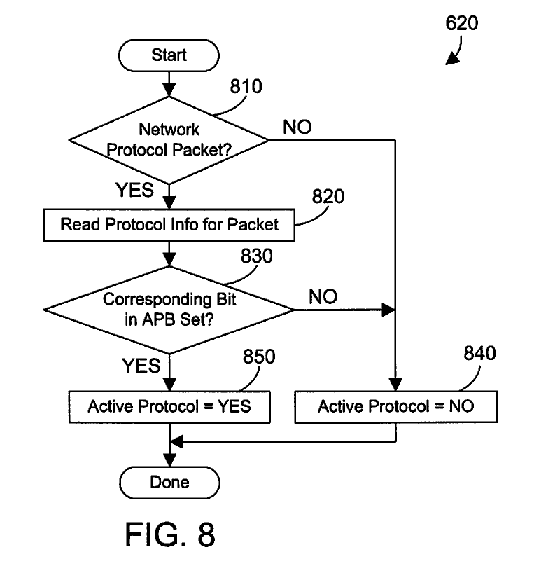

There are different possible implementations of steps 620, 630 and 640 in FIG. 6. Sample implementations for the sake of illustration are shown in FIGS. 8, 9 and 10, respectively. FIG. 8 shows a method 620 that is one possible implementation for step 620 in FIG. 6. Method 620 determines whether the inbound packet is a network protocol packet (step 810). If not (step 810=NO), active protocol is set to NO (step 840). If the packet is a protocol packet (step 810=YES), method 620 reads the protocol information for the packet (step 820). The corresponding bit in the active protocols bitmap (APB) is then read, and if the corresponding bit in the APB is set (step 830=YES), active protocol is set to YES (step 850). If the corresponding bit in the APB is not set (step 830=NO), this means the protocol in the inbound packet is inactive, so active protocol is set to NO (step 840).

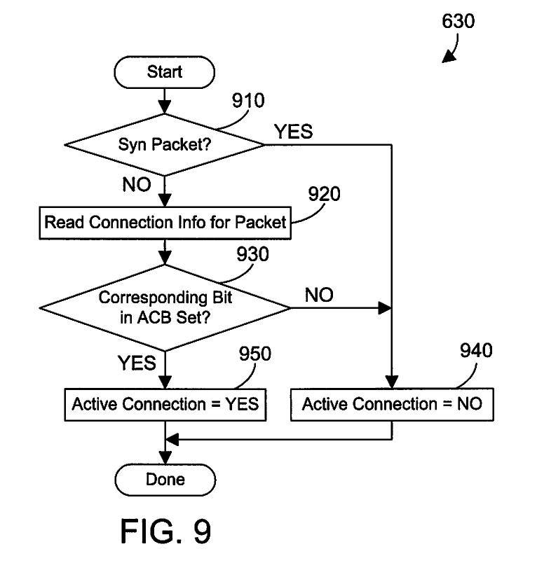

FIG. 9 shows a method 630 that is one possible implementation for step 630 in FIG. 6. Method 630 determines whether the inbound packet is a SYN packet (step 910). If so (step 910=YES), active connection is set to NO (step 940). If the packet is not a SYN packet (step 910=NO), method 630 reads the connection information for the packet (step 920). The corresponding bit in the active connections bitmap (ACB) is then read, and if the corresponding bit in the ACB is set (step 930=YES), active connection is set to YES (step 950). If the corresponding bit in the ACB is not set (step 930=NO), this means the connection in the inbound packet is inactive, so active connection is set to NO (step 940).

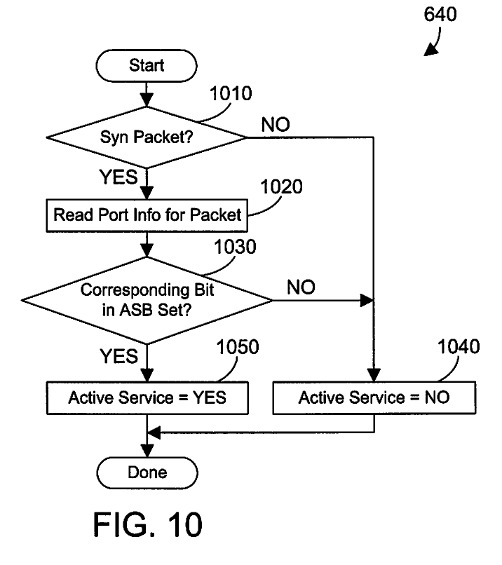

FIG. 10 shows a method 640 that is one possible implementation for step 640 in FIG. 6. Method 640 determines whether the inbound packet is a SYN packet (step 1010). A SYN (synchronize) packet is a type of packet used by the Transmission Control Protocol (TCP) to initiate or establish a new connection. A SYN packet sets the SYN flag 720 to 1 and the ACK flag 722 to 0 in the TCP header 710 shown in FIG. 7. If the inbound packet is not a SYN packet (step 1010=NO), active service is set to NO (step 1040). If the packet is a SYN packet (step 1010=YES), method 640 reads the port information for the packet (step 1020). The corresponding bit in the active services bitmap (ASB) is then read, and if the corresponding bit in the ASB is set (step 1030=YES), active service is set to YES (step 1050). If the corresponding bit in the ASB is not set (step 1030=NO), this means the service in the inbound packet is inactive, so active service is set to NO (step 1040).

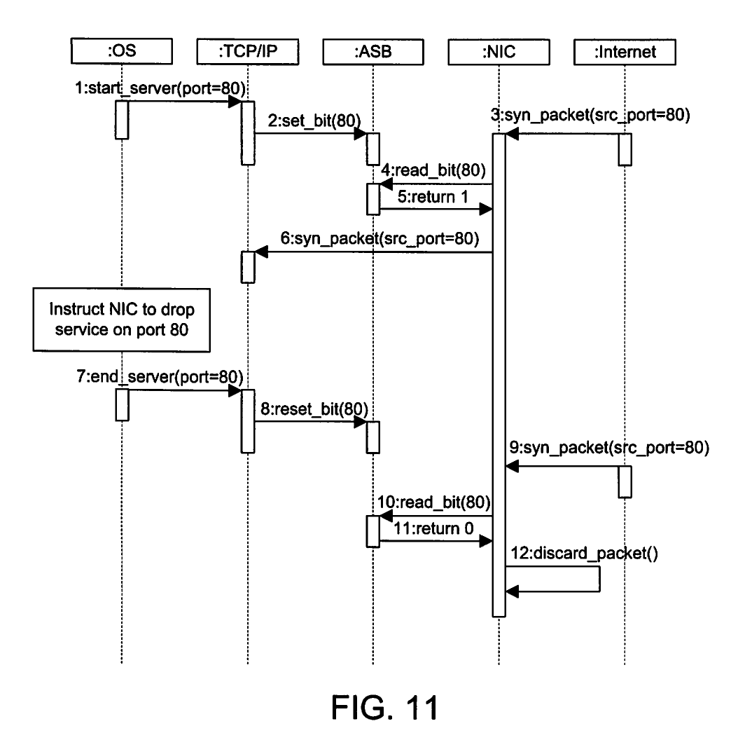

Some simple examples are now provided to illustrate the filtering of unwanted packets in a network interface. FIG. 11 shows an interaction diagram that shows the interaction between an operating system, a TCP/IP network control mechanism, an active services bitmap (ASB), a network interface card (NIC), and a source of inbound packets such as the internet. Note that the operating system (:OS) in FIG. 11 corresponds to operating system 122 in FIG. 1; :TCP/IP corresponds to the network control mechanism 123; :ASB corresponds to the active services bitmap 225 in FIG. 2, which is one specific implementation of the active services 125 in FIG. 1; :NIC corresponds to the network interface 150 that includes an inbound packet filter mechanism 152; and :Internet corresponds to a source of an inbound packet, such as the internet. FIG. 11 starts with the operating system starting an HTTP server on port 80 (step 1). In response, the TCP/IP stack sets bit (80) in the active services bitmap (ASB) to indicate port 80 corresponds to an active service (step 2). Next, a SYN packet is received by the network interface that targets ports 80, such as syn_packet (src_port=80) (step 3). In response, the network interface reads bit 80 in the ASB to see if port 80 is an active service (step 4). The ASB returns a one, indicating that port 80 corresponds to an active service (step 5). As a result, the SYN packet is sent by the network interface to the TCP/IP stack for processing (step 6).

At this point we assume the operating system instructs the network interface to drop the HTTP service on port 80 by sending the end_server (port=80) message to the TCP/IP stack (step 7). In response, the TCP/IP stack resets bit 80 in the ASB (step 8). Then a SYN packet that targets port 80 is received by the network interface (step 9). The network interface reads bit 80 from the ASB (step 10), which returns a zero (step 11), indicating that the service on port 80 is not active. As a result, the network interface discards the packet (step 12). We see from this simple example that a host may very quickly block packets for a given port (or service) by simply clearing the corresponding bit in the active services bitmap.

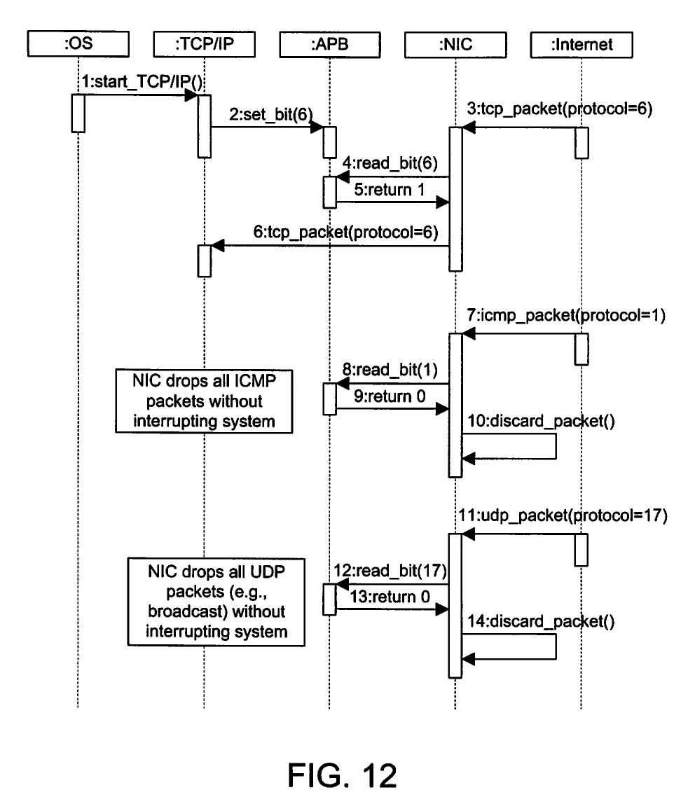

FIG. 12 shows a simple example of filtering of unwanted protocol packets. To start, the operating system initializes the TCP/IP stack by executing start_TCP/IP( ). In response, the TCP/IP stack sets bit 6 in the active protocol bitmap (APB) (step 2), which we assume for this example corresponds to TCP protocol. Next, a TCP packet is received by the network interface (step 3). The network interface reads bit 6 of the APB (step 4), which returns a one (step 5) indicating that TCP is an active protocol. In response the TCP packet is sent to the TCP/IP stack (step 6) for processing. The network interface will delete all packets that specify inactive protocols. Two examples of this are shown in FIG. 12. An ICMP packet is received in step 7. In response, the network interface reads bit 1 of the APB (step 8), which returns a zero to indicate that ICMP is an inactive protocol (step 9). As a result, the network interface discards the ICMP packet (step 10). In similar fashion, a UDP packet is received in step 11. In response, the network interface reads bit 17 of the APB (step 12), which returns a zero to indicate that UDP is an inactive protocol (step 13). As a result, the network interface discards the UDP packet (step 14).

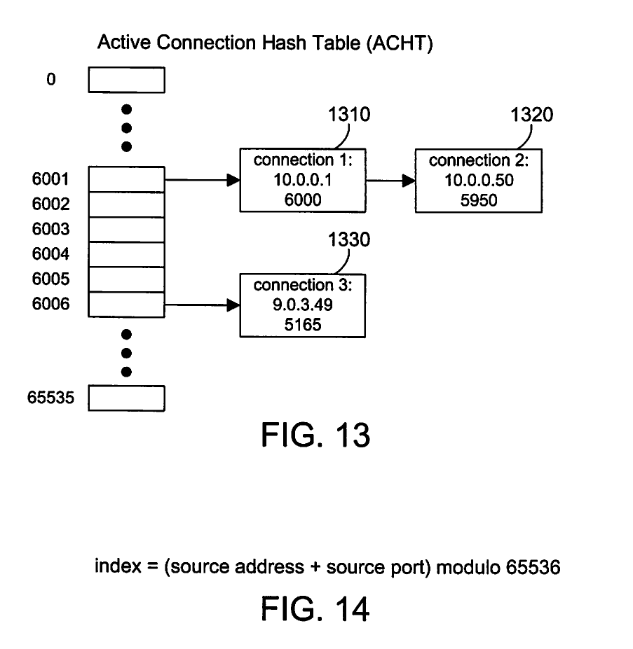

The active connections bitmap (ACB) shown at 226 in FIG. 2 may not have a sufficient number of bits to represent all possible connections by computer system 100. As a result, one bit may have to represent multiple connections. A simple example of this is shown in FIGS. 13 and 14. FIG. 13 shows an active connection hash table ACHT that has a total size of 65,536 bits. We assume for this example that connections 1 and 2 are both referenced through entry 6001 in the hash table, and connection 3 is references through entry 6006 in the hash table. The hashing algorithm for this simple example is shown in FIG. 14, where the source address and source port are added and a modulo is performed based on 65536. For each bit in the ACB, there is a corresponding bucket in the ACHT. That is, the corresponding ACB bit is set to 1 for every in-use bucket and set to 0 for all empty buckets. When a new connection is established, it is added to the appropriate bucket and the corresponding ACB bit is set to 1. When a connection terminates, it is removed from the bucket, and if the bucket is now empty, the corresponding ACB bit is set to 0. The result is an index into the hash table that allows mapping a single entry in the index to multiple connections. This way, an active connections bitmap 226 may include bits that may represent multiple connections, as shown by connection 1 (1310) and connection 2 (1320) sharing the same bucket 6001 in the ACHT. Note, if connection 1 (1310) is ended, the corresponding ACB bit is not set to 0, because connection 2 (1320) still occupies the bucket.

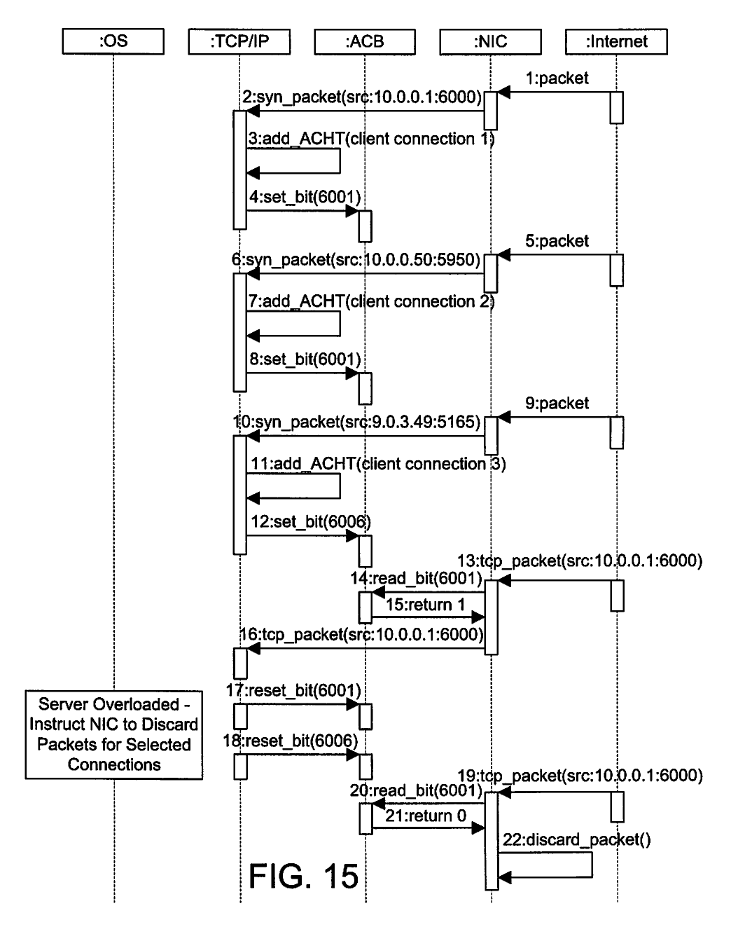

FIG. 15 shows a simple example of packet filtering in a network interface based on active connections. A packet is received by the network interface (step 1). The packet, which is a SYN packet that references a source IP address of 10.0.0.1 and a source port of 6000, is sent by the network interface to the TCP/IP stack (step 2). The TCP/IP stack then adds an entry to the hash table for client connection 1 to the active connection hash table (ACHT) (step 3), as shown at 1310 in FIG. 13. The TCP/IP stack then sets bit 6001 in the active connections bitmap (ACB) (step 4). Next, a packet is received by the network interface (step 5). The packet, which is a SYN packet that references a source IP address of 10.0.0.50 and a source port of 5950, is sent by the network interface to the TCP/IP stack (step 6). In response, the TCP/IP stack adds an entry to the ACHT for client connection 2 (step 7), as shown at 1320 in FIG. 13. The TCP/IP stack then sets bit 6001 in the ACB (step 8). Note the hashing algorithm in FIG. 14 results in connection 1 (1310) and connection 2 (1320) being assigned to the same bucket in the ACHT. A packet is then received by the network interface (step 9). The packet, which is a SYN packet that references a source IP address of 9.0.3.49 and a source port of 5165, is sent by the network interface to the TCP/IP stack (step 10). The TCP/IP stack then adds an entry to the ACHT for client connection 3 (step 11), as shown at 1330 in FIG. 13. The TCP/IP stack then sets bit 6006 in the ACB (step 12).

Next, a TCP packet is received by the network interface (step 13) that specifies a source IP address of 10.0.0.1 and a source port of 6000. The network interface reads bit 6001 from the ACB (step 15), which returns a 1 (step 15) to indicate the connection is active. In response, the TCP packet is sent by the network interface to the TCP/IP stack (step 16). We now assume the server becomes overloaded and wants to reduce its network traffic by instructing the network interface to discard packets for selected connections. Thus, the TCP/IP stack resets bit 6001 (step 17), which indicates connections 1 and 2 are inactive, and resets bit 6006 (step 18), which indicates connection 3 is inactive. Now we assume a TCP packet is received by the network interface that specifies a source IP address of 10.0.0.1 and a source port of 6000 (step 19). The network interface reads bit 6001 (step 20), which returns 0 (step 21). As a result, the network interface discards the packet (step 22).

Filtering in the network interface according to an indication of active services, active connections and active protocols allows dynamic and effective filtering of a vast majority of unwanted packets. As a result, processors on a server is freed up from the overhead of processing unwanted packets because the unwanted packets are blocked by the network interface before they can affect processor performance. In the case of a TCP/IP stack, if TCP detects an attack on a particular service, TCP can instantly shut down the service by setting the corresponding ASB bit to 0, causing the network interface to instantly discard all inbound SYN packets for that service. If TCP detects an attack on a particular connection, TCP can instantly shut down the connection by setting the corresponding ACB bit to 0, causing the network interface to instantly discard all inbound packets for that connection. If IP detects an attack on a particular protocol (e.g., ICMP echo (ping) attack), IP can instantly shut down the protocol by setting the corresponding APB bit to 0, causing the network interface to instantly discard all inbound packets for that protocol.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

What is claimed is:

1. An apparatus comprising:
at least one processor;
a memory coupled to the at least one processor, the memory including a shared memory portion;
a network control mechanism residing in the memory and executed by the at least one processor, the network control mechanism writing to the shared memory portion to indicate active services, active connections and active protocols; and
a network interface coupled to the at least one processor, the network interface comprising an inbound packet filter mechanism that reads an incoming packet to determine a service, a connection, or a protocol for the incoming packet, the inbound packet filter mechanism deleting the inbound packet if the service, the connection or the protocol for the inbound packet is not an active service, an active connection, or an active protocol indicated in the shared memory portion.

2. The apparatus of claim 1 wherein the shared memory portion comprises an active services bitmap that includes a bit corresponding to each supported service.

3. The apparatus of claim 1 wherein the shared memory portion comprises an active connection bitmap that includes a bit corresponding to each active and inactive connection.

4. The apparatus of claim 1 wherein the shared memory portion comprises an active protocol bitmap that includes a bit corresponding to each supported protocol.

5. The apparatus of claim 1 wherein the inbound packet filter mechanism sends the inbound packet to an appropriate target if the inbound packet specifies a service that is an active service in the shared memory portion.

6. The apparatus of claim 1 wherein the inbound packet filter mechanism sends the inbound packet to an appropriate target if the inbound packet specifies a connection that is an active connection in the shared memory portion.

7. The apparatus of claim 1 wherein the inbound packet filter mechanism sends the inbound packet to an appropriate target if the inbound packet specifies a protocol that is an active protocol in the shared memory portion.

8. A method for a network interface to process an inbound packet, the method comprising the steps of:
writing to a shared portion of a memory information that indicates active services, active connections and active protocols;
receiving the inbound packet, and reading the inbound packet to determine a service, a connection or a protocol for the inbound packet;
reading the shared portion of memory to determine whether the service, the connection, or the protocol for the inbound packet is an active service, an active connection, or an active protocol; and
deleting the inbound packet if the service, the connection, or the protocol for the inbound packet is not an active service, an active connection, or an active protocol.

9. The method of claim 8 wherein the shared portion of the memory comprises an active services bitmap that includes a bit corresponding to each supported service.

10. The method of claim 8 wherein the shared portion of the memory comprises an active connection bitmap that includes a bit corresponding to each active and inactive connection.

11. The method of claim 8 wherein the shared portion of the memory comprises an active protocol bitmap that includes a bit corresponding to each supported protocol.

12. The method of claim 8 further comprising the step of sending the inbound packet to an appropriate target if the inbound packet specifies a service that is an active service in the shared memory portion.

13. The method of claim 8 further comprising the step of sending the inbound packet to an appropriate target if the inbound packet specifies a connection that is an active connection in the shared memory portion.

14. The method of claim 8 further comprising the step of sending the inbound packet to an appropriate target if the inbound packet specifies a protocol that is an active protocol in the shared memory portion.

15. A computer-readable program product comprising:
an inbound packet filter mechanism that reads an incoming packet to determine a service, a connection, or a protocol for the incoming packet, the inbound packet filter mechanism deleting the inbound packet if the service, the connection or the protocol for the inbound packet is not an active service, an active connection, or an active protocol indicated a shared portion of memory; and
recordable media bearing the inbound packet filter mechanism.

16. The program product of claim 15 wherein the shared memory portion comprises an active services bitmap that includes a bit corresponding to each supported service.

17. The program product of claim 15 wherein the shared memory portion comprises an active connection bitmap that includes a bit corresponding to each active and inactive connection.

18. The program product of claim 15 wherein the shared memory portion comprises an active protocol bitmap that includes a bit corresponding to each supported protocol.

19. The program product of claim 15 wherein the inbound packet filter mechanism sends the inbound packet to an appropriate target if the inbound packet specifies a service that is an active service in the shared memory portion.

20. The program product of claim 15 wherein the inbound packet filter mechanism sends the inbound packet to an appropriate target if the inbound packet specifies a connection that is an active connection in the shared memory portion.

21. The program product of claim 15 wherein the inbound packet filter mechanism sends the inbound packet to an appropriate target if the inbound packet specifies a protocol that is an active protocol in the shared memory portion.
